(19) United States
(12) Patent Application Publication
(10) Pub. No.: US 2013/0188479 A1
(43) Pub. Date: Jul. 25, 2013

(54) METHOD, COMPUTER PROGRAM AND APPARATUS FOR DETERMINING A BACK-OFF VALUE

(71) Applicants: Anna Pantelidou, Oulu (FI); Timo Koskela, Oulu (FI); Sami-Jukka Hakola, Kempele (FI); Samuli Turtinen, Ii (FI)

(72) Inventors: Anna Pantelidou, Oulu (FI); Timo Koskela, Oulu (FI); Sami-Jukka Hakola, Kempele (FI); Samuli Turtinen, Ii (FI)

(73) Assignee: RENESAS MOBILE CORPORATION, Tokyo (JP)

(21) Appl. No.: 13/358,174

(22) Filed: Jan. 25, 2012

(30) Foreign Application Priority Data
Jan. 25, 2012 (GB) 1201216.7

(51) Int. Cl. H04W 28/02; H04W 72/04

(52) U.S. Cl. 370/229; 370/336

(57) ABSTRACT

One embodiment of the invention provides a method for determining a back-off window value for accessing a transmission channel. The method comprises receiving, at a first wireless node, a first set of time-varying parameters for at least one second wireless node; and using, by the first wireless node, the received first set of time-varying parameters at least partially and a second set of time-varying parameters of the first wireless node in determining a back-off window value for the first wireless node for accessing the transmission channel.

### CROSS-REFERENCE TO RELATED APPLICATION

This application is based upon and claims the benefit of priority under 35 USC 119 of UK Patent Application No. 1201216.7 filed on Jan. 25, 2012, the entire disclosure of which is incorporated herein by reference.

### FIELD OF THE INVENTION

The invention relates to accessing a communication network. More specifically, the invention provides a solution for determining a back-off value for a communication network access.

### BACKGROUND OF THE INVENTION

Normally wireless devices use in communication with each other a so-called infrastructure mode in which transmission channel opportunities are equally divided between access points and wireless devices attached to it. A temporary network or an ad hoc network may be formed, for example, when an infrastructure support is not available or the network deployment has to be able to react to dynamic changes. In the ad hoc network wireless devices communicate with each other directly (device to device communication) without using other common resources, for example, base stations for the communication. Furthermore, it can be assumed that the ad hoc network is deployed to support a specific service, such as emergency communication for government officials on a disaster site, etc.

For example, Institute of Electrical and Electronics Engineering (IEEE) 802.11 technologies support device to device communication by offering an ad hoc communication mode via the Independent Basic Service Set (IBBS) function. On the other hand, device to device communication may be supported by future cellular technologies such as Long Term Evolution Advanced (LTE-A) and its further evolutions and derivatives. In general, the device to device may be supported in the future also by other networks, for example, Global System for Mobile Communications (GSM), Wideband Code Division Multiple Access (WCDMA), Worldwide Interoperability for Microwave Access (WIMAX) etc.

When multiple users use the same transmission medium in a time division scheme, different users may not transmit simultaneously. In order to facilitate distributed time division multiple access scheme between users on the same channel the IEEE 802.11, for example, utilizes Carrier Sense Multiple Access (CSMA). The channel access is based on sensing the transmission medium and determining the opportunity for transmission based on that sensing result. If the channel is occupied, the device calculates a back-off value based on specific metrics to defer its transmission. As an example, in 802.11 such value is selected from a specific set of values, from the so-called “contention window”. Each decision to defer transmission, for any given data packet, increases the contention window value from where the next deferring period value is selected.

It is possible to take into account, for example, the transmitting node's quality of service (QoS) classes when determining the back-off window value to be used. For example, IEEE 802.11e defines different back-off window values for different QoS classes. This solution, however, would merely categorize destinations into four classes within which their respective back-off values would be computed similarly.

Based on the above, there is a need for a more efficient solution in providing transmission channel access.

### SUMMARY

According to a first aspect of the invention, there is provided a method for determining a back-off window value for accessing a transmission channel. The method comprises receiving, at a first wireless node, a first set of time-varying parameters for at least one second wireless node; and using, by the first wireless node, the received first set of time-varying parameters at least partially and a second set of time-varying parameters of the first wireless node in determining a back-off window value for the first wireless node for accessing the transmission channel.

In one embodiment, the first set of time-varying parameters comprise at least one of: number of packets in a buffer of the at least one second wireless node; average packet size of packets in a buffer of the at least one second wireless node; a total buffer size of the at least one second wireless node; relative buffer size of the at least one second wireless node; quality of service requirements of traffic of the at least one second wireless node; and weight associated with the at least one second wireless node.

In one embodiment, the second set of time-varying parameters comprise at least one of: number of packets in a buffer of the first wireless node; average packet size of packets in a buffer of the first wireless node; a total buffer size of the first wireless node; relative buffer size of the first wireless node; quality of service requirements of traffic of the first wireless node; a transmission rate of the first wireless node; a size of the neighborhood of the first wireless node; and weight associated with the first wireless node.

In one embodiment, the size of the neighborhood of the first wireless node is dependent on at least one of time, transmission channel conditions, congestion, and traffic variations.

In one embodiment, the method comprises computing, by the first wireless node, the relative buffer size for each wireless node based on a maximum queue size of the other wireless nodes within the neighborhood, an average queue size of the other wireless nodes within the neighborhood, or the maximum buffer size of the other wireless nodes within the neighborhood.

In one embodiment, the method comprises causing transmission of time-varying parameters of the first wireless node via the transmission channel.

In one embodiment, the receiving comprises receiving, at the first wireless node, the first set of time-varying parameters for the at least one second wireless node via at least one of a broadcast transmission and a unicast transmission.

According to a second aspect of the invention, there is provided a computer program comprising program code comprising instructions for performing the method of the embodiments of the invention. In one embodiment, the computer program is embodied on a computer-readable medium.

According to a third aspect of the invention there is provided a computer-readable medium comprising program code comprising instructions which, when executed on an apparatus cause the apparatus to perform the method of the first aspect.

According to a fourth aspect of the invention, there is provided an apparatus for determining a back-off window value for accessing a transmission channel. The apparatus comprises means for receiving a first set of time-varying parameters for at least one second wireless node; and means for using the received first set of time-varying parameters at least partially and a second set of time-varying parameters of the first wireless node in determining a back-off window value for the first wireless node for accessing the transmission channel.

In one embodiment, the apparatus comprises means for computing the relative buffer size for each wireless node based on a maximum queue size of the other wireless nodes within the neighborhood, an average queue size of the other wireless nodes within the neighborhood, or the maximum buffer size of the other wireless nodes within the neighborhood.

In one embodiment, the apparatus comprises means for determining to transmit time-varying parameters of the apparatus via the transmission channel.

In one embodiment, the means for receiving are configured to receive the first set of time-varying parameters for the at least one second wireless node via at least one of a broadcast transmission and a unicast transmission.

According to a fifth aspect of the invention, there is provided an apparatus for determining a back-off window value for accessing a transmission channel. The apparatus comprises at least one processor; and at least one memory including computer program code, the memory and the computer program code configured to, with the at least one processor, cause the apparatus to perform at least the following: receive a first set of time-varying parameters for at least one second wireless node; and use the received first set of time-varying parameters at least partially and a second set of time-varying parameters of the first wireless node in determining a back-off window value for the first wireless node for accessing the transmission channel.

In one embodiment, the at least one processor is configured to compute the relative buffer size for each wireless node based on a maximum queue size of the other wireless nodes within the neighborhood, an average queue size of the other wireless nodes within the neighborhood, or the maximum buffer size of the other wireless nodes within the neighborhood.

In one embodiment, the at least one processor is configured to cause a transmitter to transmit time-varying parameters of the apparatus via the transmission channel.

In one embodiment, the at least one processor is configured to receive the first set of time-varying parameters for the at least one second wireless node via at least one of a broadcast transmission and a unicast transmission.

In one embodiment, the first set of time-varying parameters comprise at least one of: number of packets in a buffer of the at least one second wireless node; average packet size of packets in a buffer of the at least one second wireless node; a total buffer size of the at least one second wireless node; relative buffer size of the at least one second wireless node; quality of service requirements of traffic of the at least one second wireless node; and weight associated with the at least one second wireless node.

In one embodiment, the second set of time-varying parameters comprise at least one of: number of packets in a buffer of the first wireless node; average packet size of packets in a buffer of the first wireless node; a total buffer size of the first wireless node; relative buffer size of the first wireless node; quality of service requirements of traffic of the first wireless node; a transmission rate of the first wireless node; a size of the neighborhood of the first wireless node; and weight associated with the first wireless node.

In one embodiment, the size of the neighborhood of the first wireless node is dependent on at least one of time, transmission channel conditions, congestion and traffic variations.

In one embodiment, the apparatus is configured to operate in an ad hoc mode. In another embodiment, the apparatus is configured to operate in an infrastructure mode.

In one embodiment, the apparatus is a mobile terminal. In one embodiment, the mobile apparatus is a mobile phone.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a block diagram illustrating a method according to one embodiment of the invention;

FIG. 2 illustrates a networking environment of a wireless node according to one embodiment of the invention;

FIG. 3A illustrates a flow diagram for determining a back-off window value according to one embodiment of the invention;

FIG. 3B illustrates a flow diagram for determining a back-off window value according to one embodiment of the invention; and

FIG. 4 illustrates an apparatus according to one embodiment of the invention.

### DETAILED DESCRIPTION OF THE INVENTION

Reference will now be made in detail to the embodiments of the present invention, examples of which are illustrated in the accompanying drawings.

FIG. 1 illustrates a block diagram illustrating a method according to one embodiment of the invention. At step 100, a first wireless node receives via a transmission channel, a first set of time-varying parameters for at least one second wireless node. Some of the second wireless nodes may be reachable directly (via one hop) and some via multiple hops. At step 102, the first wireless node uses the received first set of time-varying parameters at least partially and a second set of time-varying parameters of the first wireless node in determining a back-off window value for the first wireless node for accessing the transmission channel. In other words, the first wireless node uses time-varying parameters received from other wireless nodes in the process of determining its back-off window value. The time-varying parameters of the at least one second wireless node comprise, for example, information reflecting the buffer status of the at least one second wireless node. Furthermore, the transmission channel may be any transmission channel that is able to transmit wireless signals when device to device communication is performed.

An advantage of the embodiment disclosed in FIG. 1 is that it provides a dynamic and adaptable access mechanism that takes into account time varying network characteristics. Furthermore, when buffer status information of the wireless nodes is used determining a back-off window value for a single wireless node, this provides a mechanism to offer queue balancing between the nodes based on at least one of the relative amount of data they have, on their achievable transmission rate, and on their traffic priority rather than utilizing a fixed metric which could cause channel access starvation.

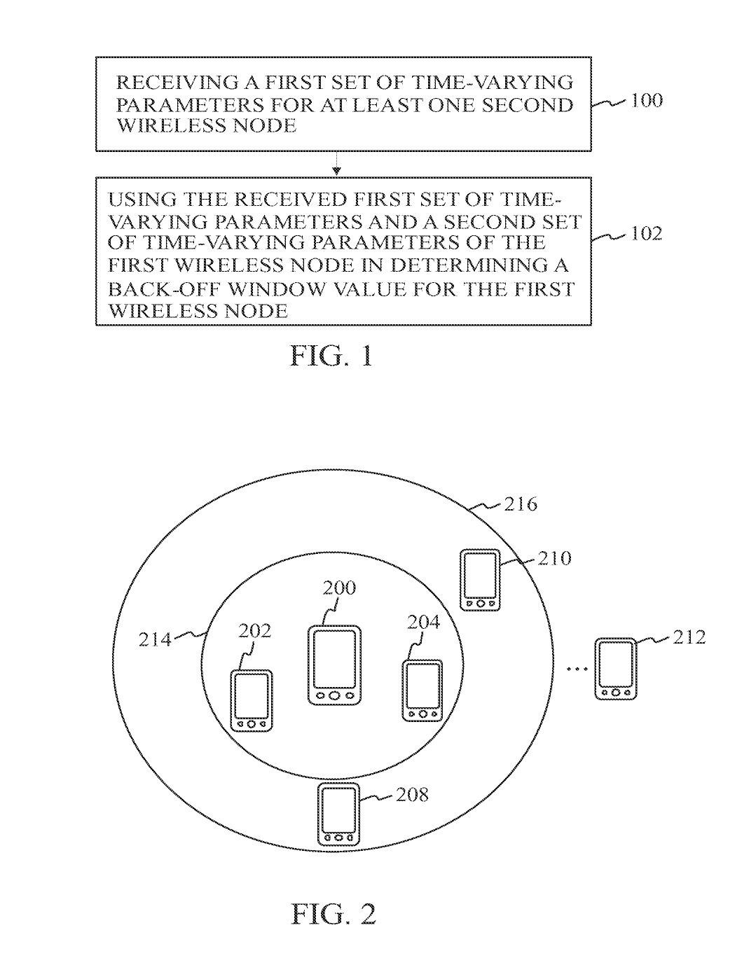

FIG. 2 illustrates a networking environment of a wireless node 200 according to one embodiment of the invention. The wireless node 200 has K members (other wireless nodes 202-212) in its network. The K members are reachable by the wireless node 200 directly (via one hop) (wireless nodes 202 and 204) or via multiple hops (wireless nodes 208, 210 and 212). Multiple hops may exist in the network when routing between the nodes is supported. When the number of hops to other wireless nodes equals to one, the wireless node's 200 neighborhood is equivalent to a collision domain 216 of the wireless device.

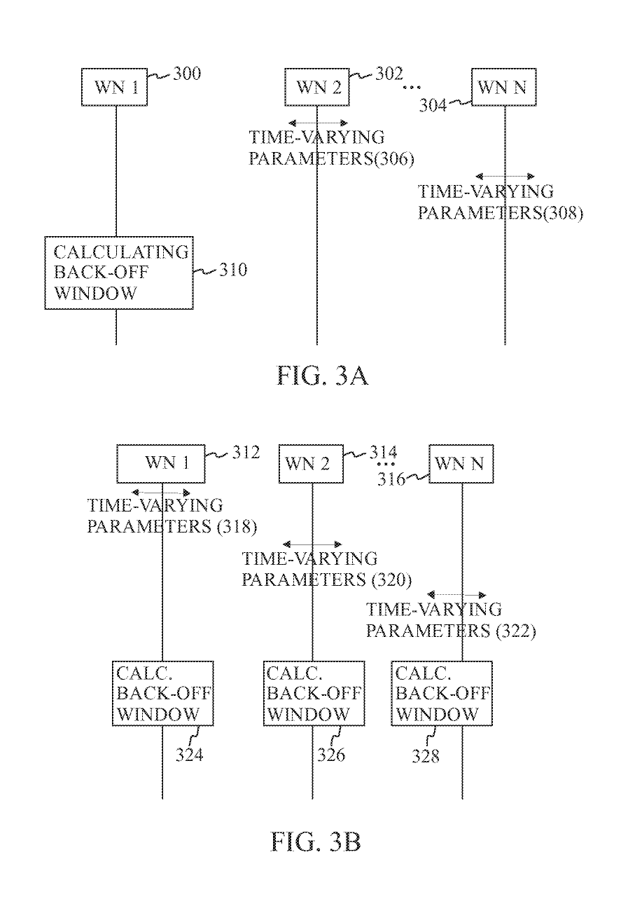

FIG. 3A illustrates a flow diagram for determining a back-off window value for accessing a transmission channel according to one embodiment of the invention. A wireless node 300 receives time-varying parameters relating to wireless nodes 302 and 304 from the wireless nodes 302 and 304. The time-varying parameters comprise, for example, buffer status information 306 and 308 from the wireless nodes 302 and 304. The wireless node 300 uses the time-varying parameters received from the wireless nodes 302 and 304 at least partially and its own time-varying parameters in determining a back-off window value for the first wireless node for accessing the transmission channel. For simplicity, FIG. 3A illustrates that the wireless device 300 receives time-varying parameters only from two wireless nodes 302 and 304. It is evident that the number of wireless nodes may be larger than that in other embodiments of the invention. Furthermore, although not shown in FIG. 3A, the wireless node 300 may send its own time-varying parameters to one or more other wireless nodes, for example, to wireless nodes 302 and 304.

In one embodiment, only a subset of the received time varying parameters received from the wireless nodes are selected for deriving the back-off window value.

In one embodiment, the size of neighborhood of the wireless node 300 is adapted dynamically. The size can be time-varying and may depend, for example, on transmission channel conditions, congestions, traffic variations or other conditions. This controls and reduces overhead for message exchange for example in low load or low congestion. Furthermore, information about which wireless devices belong to the neighborhood of the wireless node 300 may be transmitted, for example, using any appropriate routing protocol. With this information the wireless nodes are informed about the paths from each node to another node.

In one embodiment, the time-varying parameters relating to the other wireless nodes (for example, wireless nodes 302 and 304 in FIG. 3A) and used in determining the back-off window value comprise at least one of: number of packets in a buffer of the wireless node; average packet size of packets in a buffer of the wireless node; a total buffer size of the wireless node; quality of service requirements of traffic of the wireless node; and weight associated with the wireless node. Each of these parameters may be wireless node specific. For example, the wireless node 300 may use in determining its back-off window information on the number of packets in a buffer of all the wireless nodes (including itself) in its neighborhood or only the number of packets in a buffer of a subset of the wireless nodes.

In one embodiment, a relative buffer size for each wireless node is computer based on a maximum queue size of the other wireless nodes within the neighborhood, an average queue size of the other wireless nodes within the neighborhood, or the maximum buffer size of the other wireless nodes within the neighborhood. This means that the wireless node 300 may take into account buffer statuses of some or all wireless nodes in its neighborhood when determining the relative buffer size of the wireless node 300. In another embodiment, the relative buffer size may be equal with an actual buffer size of a wireless node.

In one embodiment, the wireless node 300 may receive time-varying parameters from multiple wireless nodes but use only information received from those wireless nodes that are within its collision domain.

In one embodiment, the back-off window value is given by a function that is parameterized as follows:

f (BSₖₙ, Dₙ, R, Wₖ; k=0, 1, 2, 3, . . . , K; n=0, 1, 2, 3, . . . , N)

BSₖₙ indicates the buffer status of a k^{th} wireless node that is n hops away. BSₖₙ may also be a relative buffer size of the k^{th} wireless node that is n hops away. Dₙ is the distance in hops of the k^{th} wireless node. R is the achievable instantaneous transmission rate of the wireless node 300. Wₖ is the weight associated with the traffic of the k^{th} wireless node. The weight may depend, for example, on a node's location, traffic type or class, congestion or on any combination of these. The weight may also be time dependent. Furthermore, the weight can be used to give certain preference for a specific node over other nodes. The weight may be determined, for example, by a network operator. In one embodiment, the initial back-off window value is computed with the above function and the next back-off window values are computed from the initial back-off window value based on a different back-off algorithm. Furthermore, the function f may be a function of time and it may depend on its parameters with different relationships over different time instants.

The function f above may have the following properties:
It is decreasing in the relative buffer size assuming that all the rest parameters are fixed
It is decreasing on the transmission rate if all the rest parameters are fixed
It is decreasing on Wₖ if the rest of the parameters are fixed. This captures the property that higher priority traffic weighs more so that the current window size becomes smaller.

FIG. 3B illustrates a flow diagram for determining a back-off window value according to one embodiment of the invention. The arrangement disclosed in FIG. 3B comprises an arbitrary number of wireless nodes 312-316. In FIG. 3B the wireless nodes operate in an ad hoc mode and form an ad hoc network, and the communication is performed purely between the wireless nodes. The forming of the ad hoc network is performed any appropriate way. The wireless nodes 312-316 are forming, for example, an IEEE 802.11s ad hoc network.

In one embodiment of FIG. 3B one or more of the wireless nodes 312-316 can be a mesh node/access point. In one embodiment, the wireless node 312 acts as a mesh node/access point. A mesh node that is also an access point is a mesh node that can basically provide services to wireless nodes that are not mesh stations but are just IEEE 802.11 nodes. This is a way to interconnect a mesh with another network. Some other node or nodes may also be mesh portals to further connect the mesh to the Internet.

The wireless nodes 312-316 use CSMA-based (CSMA, Carrier Sense Multiple Access) contention access with a back-off function to access a transmission channel. Time-varying parameters are exchanged between the wireless nodes 312-316 in steps 318-322. The information exchange is performed, for example, using broadcast messaging. In another embodiment, unicast messaging is used. Is it also possible that some of the information exchange is performed using broadcast messaging and some using unicast messaging. After receiving the necessary pieces of information, the wireless nodes 312-316 each calculate a back-off window value, as indicated by references 324-328.

The time-varying parameters used in determining the back-off window value may comprise at least one of: number of packets in a buffer of the wireless nodes; average packet size of packets in a buffer of the wireless nodes; a total buffer size of the wireless nodes; quality of service requirements of traffic of the wireless nodes; and weight associated with the wireless nodes. Each of these parameters may be wireless node specific. Furthermore, only a subset of available pieces of information may be used in determining the back-off window value. For example, a wireless node may use in determining its back-off window information on the number of packets in a buffer of all the wireless nodes (including itself) in its neighborhood or only the number of packets in a buffer of a subset of the wireless nodes. In one embodiment, the calculated back-off window value is then used as an initial value for the back-off window. The back-off window value is calculated, for example, with the aforementioned function f.

The weight parameter in the function may be assigned, for example, by a network operator or they can be preset parameters on the wireless nodes.

An advantage of the embodiment disclosed in FIG. 3B is that it provides automatic scaling of resources between the wireless nodes 312-316. This means that the wireless nodes do not get equal access durations but also their transmission rates are scaled according to what other wireless nodes in the neighborhood have communicated so far.

Although IEEE 802.11 type of networks and CSMA has been used as an example of a possible implementation environment, the invention is applicable in any communication system which utilizes back-off window mechanisms, for example, a WCDMA network, LTE-based D2D (Device to Device) in ad-hoc mode, D2D communication in infrastructure mode etc.

In one embodiment of FIG. 3A or 3B, the wireless node is a mobile terminal, for example, a mobile phone.

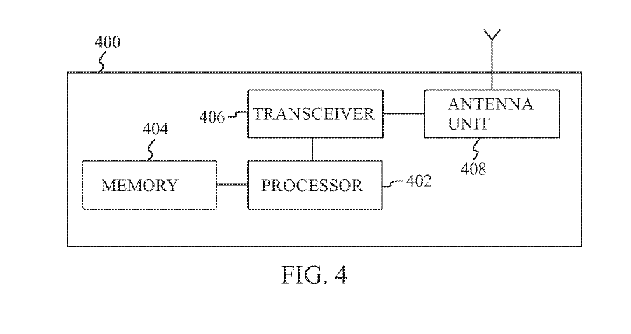

FIG. 4 discloses a simplified block diagram of an exemplary apparatus that is suitable for use in practicing the exemplary embodiments of at least part of this invention. In FIG. 4, the apparatus 400 may include a processor 402 and a memory 404 coupled to the processor 402. The apparatus 400 may also include a suitable transceiver 406 (having a transmitter (TX) and a receiver (RX)) coupled to the processor 402 and to an antenna unit 408.

The processor 402 or some other form of generic central processing unit (CPU) or special-purpose processor such as digital signal processor (DSP), may operate to control the various components of the apparatus 400 in accordance with embedded software or firmware stored in memory 404 or stored in memory contained within the processor 402 itself. In addition to the embedded software or firmware, the processor 402 may execute other applications or application modules stored in the memory 404 or made available via wireless network communications. The application software may comprise a compiled set of machine-readable instructions that configures the processor 402 to provide the desired functionality, or the application software may be high-level software instructions to be processed by an interpreter or compiler to indirectly configure the processor 402.

The transceiver 406 is for bidirectional wireless communications with another wireless device. The transceiver 406 may provide e.g. frequency shifting, converting received RF signals to baseband and converting baseband transmit signals to RF. In some descriptions a radio transceiver or RF transceiver may be understood to include other signal processing functionality such as modulation/demodulation, coding/decoding, and other signal processing functions. In some embodiments, the transceiver 406, portions of the antenna unit 408, and an analog baseband processing unit may be combined in one or more processing units and/or application specific integrated circuits (ASICs).

The antenna unit 408 may be provided to convert between wireless signals and electrical signals, enabling the apparatus 400 to send and receive information from a cellular network or some other available wireless communications network or from a peer wireless device. The antenna unit 408 may include antenna tuning and/or impedance matching components, RF power amplifiers, and/or low noise amplifiers.

The embodiments of the invention described hereinbefore, for example, in association with the figures presented may be used in any combination with each other. Several of the embodiments may be combined together to form a further embodiment of the invention.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

A processor or processors may be used in the exemplary embodiments of the invention. The processor may be a dual-core processor, a multiple-core processor, a digital signal processor, a controller etc.

The exemplary embodiments of the invention can be included within any suitable device, for example, including any suitable servers, workstations, PCs, laptop computers, PDAs, Internet appliances, handheld devices, cellular telephones, wireless devices, other devices, and the like, capable of performing the processes of the exemplary embodiments, and which can communicate via one or more interface mechanisms, including, for example, Internet access, telecommunications in any suitable form (for instance, voice, modem, and the like), wireless communications media, one or more wireless communications networks, cellular communications networks, 3G communications networks, 4G communications networks Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware art(s). For example, the functionality of one or more of the components of the exemplary embodiments can be implemented via one or more hardware devices, or one or more software entities such as modules.

The exemplary embodiments can store information relating to various processes described herein. This information can be stored in one or more memories, such as a hard disk, optical disk, magneto-optical disk, RAM (Random Access Memory), and the like. One or more databases can store the information regarding cyclic prefixes used and the delay spreads measured. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be implemented by the preparation of one or more application-specific integrated circuits or by interconnecting an appropriate network of conventional component circuits, as will be appreciated by those skilled in the electrical art(s).

As stated above, the components of the exemplary embodiments can include computer readable medium or memories according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, and the like. Common forms of computer-readable media can include, for example, a floppy disk, a flexible disk, hard disk, magnetic tape, any other suitable magnetic medium, a CD-ROM, CDRW, DVD, any other suitable optical medium, a RAM, a PROM, an EPROM, a FLASH-EPROM, any other suitable memory chip or cartridge, a carrier wave or any other suitable medium from which a computer can read.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method comprising:
receiving, at a first wireless node, a first set of time-varying parameters for at least one second wireless node; and
using, by the first wireless node, the received first set of time-varying parameters at least partially and a second set of time-varying parameters of the first wireless node in determining a back-off window value for the first wireless node for accessing a transmission channel.

2. The method according to claim 1, wherein the first set of time-varying parameters comprise at least one of:
number of packets in a buffer of the at least one second wireless node;
average packet size of packets in a buffer of the at least one second wireless node;
a total buffer size of the at least one second wireless node;
relative buffer size of the at least one second wireless node;
quality of service requirements of traffic of the at least one second wireless node; and
weight associated with the at least one second wireless node.

3. The method according to claim 1, wherein the second set of time-varying parameters comprise at least one of:
number of packets in a buffer of the first wireless node;
average packet size of packets in a buffer of the first wireless node;
a total buffer size of the first wireless node;
relative buffer size of the first wireless node;
quality of service requirements of traffic of the first wireless node;
transmission rate of the first wireless node;
size of the neighborhood of the first wireless node; and
weight associated with the first wireless node.

4. The method according to claim 3, wherein the size of the neighborhood of the first wireless node is dependent on at least one of time, transmission channel conditions, congestion and traffic variations.

5. The method according to claim 2, comprising computing, by the first wireless node, the relative buffer size for each wireless node based on a maximum queue size of the other wireless nodes within the neighborhood, an average queue size of the other wireless nodes within the neighborhood, or the maximum buffer size of the other wireless nodes within the neighborhood.

6. The method according to claim 1, comprising: causing transmission of time-varying parameters of the first wireless node via the transmission channel.

7. The method according to claim 1, wherein the receiving comprises receiving, at the first wireless node, the first set of time-varying parameters for the at least one second wireless node via at least one of a broadcast transmission and a unicast transmission.

8. A computer-readable medium comprising program code comprising instructions which, when executed on an apparatus cause the apparatus to perform the method of claim 1.

9. An apparatus comprising:
at least one processor; and
at least one memory including computer program code, the memory and the computer program code configured to, with the at least one processor, cause the apparatus to perform at least the following:
receive a first set of time-varying parameters for at least one second wireless node; and
use the received first set of time-varying parameters at least partially and a second set of time-varying parameters of the first wireless node in determining a back-off window value for the first wireless node for accessing a transmission channel.

10. The apparatus according to claim 9, wherein the first set of time-varying parameters comprise at least one of:
number of packets in a buffer of the at least one second wireless node;
average packet size of packets in a buffer of the at least one second wireless node;
a total buffer size of the at least one second wireless node;
relative buffer size of the at least one second wireless node;
quality of service requirements of traffic of the at least one second wireless node; and
weight associated with the at least one second wireless node.

11. The apparatus according to claim 9, wherein the second set of time-varying parameters comprise at least one of:
number of packets in a buffer of the first wireless node;
average packet size of packets in a buffer of the first wireless node;
a total buffer size of the first wireless node;
relative buffer size of the first wireless node;
quality of service requirements of traffic of the first wireless node;
transmission rate of the first wireless node;
size of the neighborhood of the first wireless node; and
weight associated with the first wireless node.

12. The apparatus according to claim 11, wherein the size of the neighborhood is dependent on at least one of time, transmission channel conditions, congestion and traffic variations.

13. The apparatus according to claim 10, wherein the at least one processor is configured to compute a relative buffer size for each wireless node based on a maximum queue size of the other wireless nodes within the neighborhood, an average queue size of the other wireless nodes within the neighborhood, or the maximum buffer size of the other wireless nodes within the neighborhood.

14. The apparatus according to claim 9, wherein the at least one processor is configured to cause a transmitter to transmit time-varying parameters of the apparatus via the transmission channel.

15. The apparatus according to claim 9, wherein the at least one processor is configured to receive the first set of time-varying parameters for the at least one second wireless node via at least one of a broadcast transmission and a unicast transmission.

16. The apparatus according to claim 9, where the apparatus is configured to operate in an ad hoc mode.

17. The apparatus according to claim 9, where the apparatus is configured to operate in an infrastructure mode.

18. The apparatus according to claim 9, wherein the apparatus is a mobile terminal.

19. The method according to claim 2, comprising: causing transmission of time-varying parameters of the first wireless node via the transmission channel.

20. The method according to claim 3, comprising: causing transmission of time-varying parameters of the first wireless node via the transmission channel.
